(19) United States
(12) Patent Application Publication
(10) Pub. No.: US 2007/0294185 A1
(43) Pub. Date: Dec. 20, 2007

(54) Value Added Third Party Contribution Registry

(75) Inventors: Mark A. Sullivan, Houston, TX (US); Carrie Schilling-Wilhelm, Houston, TX (US)

Correspondence Address: LOCKE LORD BISSELL & LIDDELL LLP;ATTN: IP DOCKETING, 600 TRAVIS, SUITE 3400, HOUSTON, TX, 77002-3095, US

(73) Assignee: CONTINENTAL AIRLINES, INC., Houston, TX (US)

(21) Appl. No.: 11/674,777

(22) Filed: Feb. 14, 2007

Related U.S. Application Data
(60) Provisional application No. 60/805,172, filed on Jun. 19, 2006.

(51) Int. Cl. H04L 9/00; G06Q 30/00

(52) U.S. Cl. 705/70; 705/1

(57) ABSTRACT

The present disclosure provides an improved system and method that allows a registrant to establish, generally through the Internet, an electronic account with a provider of services or products, and allows the registrant and others to add value to the account to raise the value through the collective contributory efforts. The value can include various forms such as monetary value from bank accounts and debit or credit charge cards. The value can also include in-kind value that is appropriate to the services from the provider, such as travel miles for an airline account. Still further, the provider can itself add value to the account, such as for promotional incentives. The incentives can include bonuses for timely use or the recipient's selection of certain services or products, and other promotional purposes. The collective efforts of several entities contributing to the account create a source for the recipient to select a service or product from the provider, such as travel. The system and method allows for the efficient and effective accumulation of value from multiple sources and multiple types of value that can be tracked and applied that has not been realized prior to the present invention.

### CROSS REFERENCE TO RELATED APPLICATIONS

This application claims the benefit of U.S. Provisional Application No. 60/805,172, filed Jun. 19, 2006, and is incorporated herein by reference.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO APPENDIX

Not applicable.

### BACKGROUND

1. Field of the Invention

The invention relates to electronic commerce. More specifically, the invention relates to adding value to electronically accessible accounts and using the value for services and products.

2. Description of Related Art

Electronic commerce is ubiquitous to the Internet, allowing people to purchase and sell services and products for value. For example, a person can register with an airline to establish an electronic account that receives value in the form of frequent flyer travel miles. The registrant can then apply those miles and perhaps additional value as needed from a charge card toward airline travel or other services or products offered by the airline. The account can be accessed through the registrant's browser over the Internet. Similarly, another person can electronically apply the another person's miles to purchase airline travel for the first person, but only using the another person's value from his/her account.

Further, registries are now prevalent and available over the Internet through web browsers. In a typical registry, a person will register with a store or website for a specific list of items. Others can access the registry to view the available list. The others may then elect to purchase from that list one or more of the items either by attending the store in person or through electronic commerce. The chosen gift that was selected by the registrant can be sent or given directly to the recipient. At least one online site acts as an intermediary to allow users to register gifts from many merchants, including indirectly an airline, and provides customers with one gift registry for all their gifts. Another online site is categorized as an online bridal registry that also acts as an intermediary and allows wedding guests to give travel miles for a premium price charged above the actual value of the miles. Another online site is categorized as an intermediary honeymoon registry where the honeymoon couple selects the items they want on their registry from various service providers and their guests purchase these items for them. Some of the gifts include specific flights, not miles, hotel stays, and honeymoon-assorted activities such as side trips, dinners, and so forth. A minimum amount of several thousand dollars of expenditures is required to avoid additional fees for the services.

Concurrently and independent of the Internet, more persons are receiving gift cards for specific stores for birthdays, holidays, and other special events. The public is recognizing the benefit of allowing the recipient to choose the appropriate gift.

While the above current trends are beneficial in many cases, each has shortcomings. For example, the above example of the airline industry only allows the registrant to use his/her own miles for their ticket or another's ticket, but not in combination with another's miles. The registries require those who choose the registry to still purchase the items and provide them to the recipient either directly or through by mailing. The known registries for services charge premium prices or fees for the gifts and dilute the value of the gift to the recipient. Gift cards are typically restricted to a particular store and require redemption at that store, even though the person may prefer another store. Further, any residual value in gift cards is unused and wasted, or requires additional value for a selected item.

Thus, there remains a need to improve the giving and receiving of value in electronic commerce.

### BRIEF SUMMARY

The present disclosure provides an improved system and method that allows a registrant to establish, generally through the Internet, an electronic account with a provider of services or products, and allows the registrant and others to add value to the account through the collective contributory efforts. The value can include various forms such as monetary value from bank accounts and debit or credit charge cards. The value can also include in-kind value that is appropriate to the services from the provider, such as travel miles for an airline account. Still further, the provider can itself add value to the account, such as for promotional incentives. The incentives can include bonuses for timely use or the recipient's selection of certain services or products, and other promotional purposes. The collective efforts of several entities contributing to the account create a source for the recipient to select a service or product from the provider, such as travel. The system and method allows for the efficient and effective accumulation of value from multiple sources and multiple types of value that can be tracked and applied that has not been realized prior to the present invention.

The disclosure provides a method for providing services or products for value to a registrant of a provider, comprising: allowing the registrant to activate a web based account on an electronic processor; allowing third parties other than the registrant and the provider to add monetary value into the account to establish an accumulated value for the registrant through an input device to the electronic processor; allowing the registrant to apply at least a portion of the accumulated value to selectable services or products provided by the provider; and the provider at least partially providing the selected services or products to the registrant.

The disclosure also provides a method for providing travel services for value to a registrant of an airline industry company, comprising: allowing the registrant to activate a web based account on an electronic processor; allowing third parties other than the registrant and the airline industry company to add monetary value to the account to establish an accumulated value for the registrant through an input device to the electronic processor; allowing the registrant to apply at least a portion of the accumulated value to selectable travel services provided by the airline industry company; and the airline industry company at least partially providing the travel services to the registrant.

The disclosure further provides a system for providing services or products for value to a registrant of a provider, comprising: a database; an electronic processor coupled to the database; an input device remotely linkable to the processor; an output device remotely linkable to the processor; a program coupled to the processor and database and adapted to receive input from the input device that allows: the registrant to activate a web based account; third parties other than the registrant and the provider to add monetary value to the account to establish an accumulated value for the registrant; the registrant to apply at least a portion of the added value to selectable services or products offered by the provider; and the provider to at least partially provide the selected services or products directly to the registrant.

### BRIEF DESCRIPTION OF THE DRAWINGS

While the inventions disclosed herein are susceptible to various modifications and alternative forms, only a few specific embodiments have been shown by way of example in the drawings and are described in detail below. The figures and detailed descriptions of these specific embodiments are not intended to limit the breadth or scope of the inventive concepts or the appended claims in any manner. Rather, the figures and detailed written descriptions are provided to illustrate the inventive concepts to a person of ordinary skill in the art as required by 35 U.S.C. §112.

FIG. 1, separated into two sheets of FIGS. 1A and 1B, is a schematic flowchart illustrating exemplary process steps to accomplish adding value from various parties to an account of a registrant and the registrant's use of the value.

FIG. 2 is a schematic flowchart illustrating exemplary process steps detailing adding value to the account of the registrant.

FIG. 3 is a schematic flowchart illustrating exemplary process steps detailing at least partially providing selected services or products to the registrant.

FIG. 4 is an exemplary listing of data fields for one or more records used in adding value to the account of the registrant.

FIG. 5 is an exemplary listing of data fields for one or more records used in at least partially providing the services or products to the registrant.

FIG. 6 is an exemplary system having an electronic processor and input device used to receive and process information from various parties and at least partially provide services or products to the registrant.

### DETAILED DESCRIPTION

One or more illustrative embodiments incorporating the invention disclosed herein are presented below. Not all features of an actual implementation are described or shown in this application for the sake of clarity. It is understood that the development of an actual embodiment incorporating the present invention, numerous implementation-specific decisions must be made to achieve the developer's goals, such as compliance with system-related, business-related and other constraints, which vary by implementation and from time to time. While a developer's efforts might be complex and time-consuming, such efforts would be, nevertheless, a routine undertaking for those of ordinary skill in the art having benefit of this disclosure.

The present disclosure can be used in a variety of fields of endeavor, having diverse services and products. For example, the fields can include the travel industry, such as airlines, railroad, and other public transportation; hotel and motel and other places of lodging; vehicular rental, leasing, and purchase; food products and services; products for the home, business, or personal use; medical products and services; and other services and products used by individuals. For illustration and without limitation, the below examples will be described in the general context of airline travel as the provider of the services or goods directly to the registrant without the need for an intermediary organization with the specific understanding the one with ordinary skill in the art could understand and apply such an example to other fields of endeavor given the teaching therein.

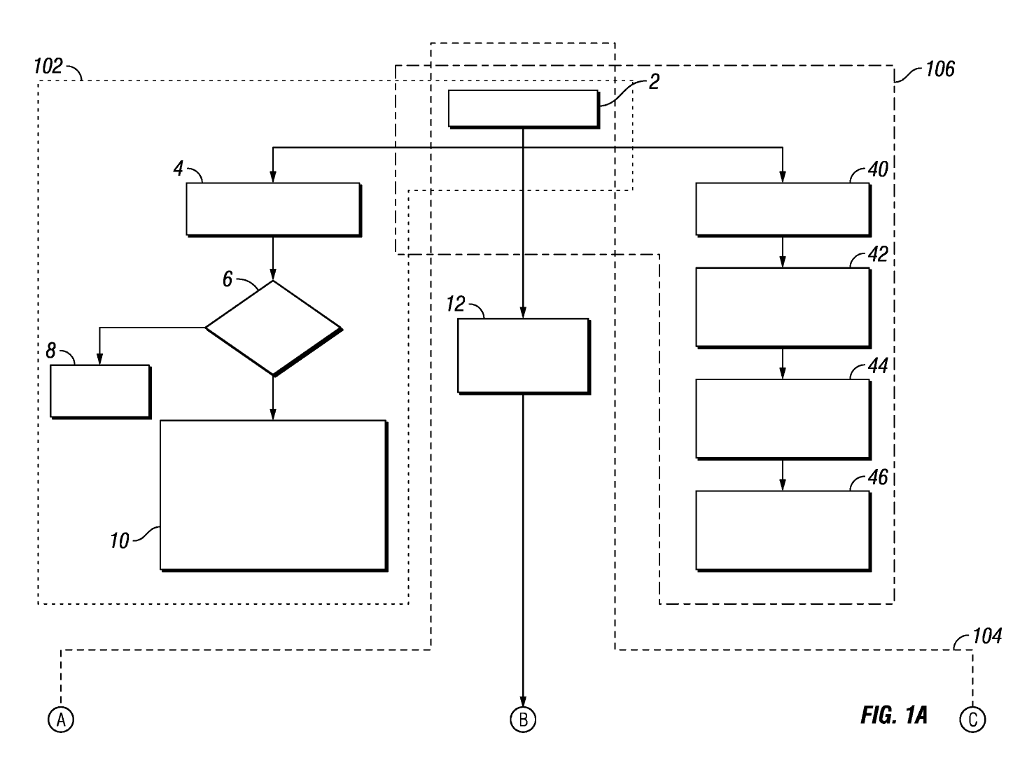

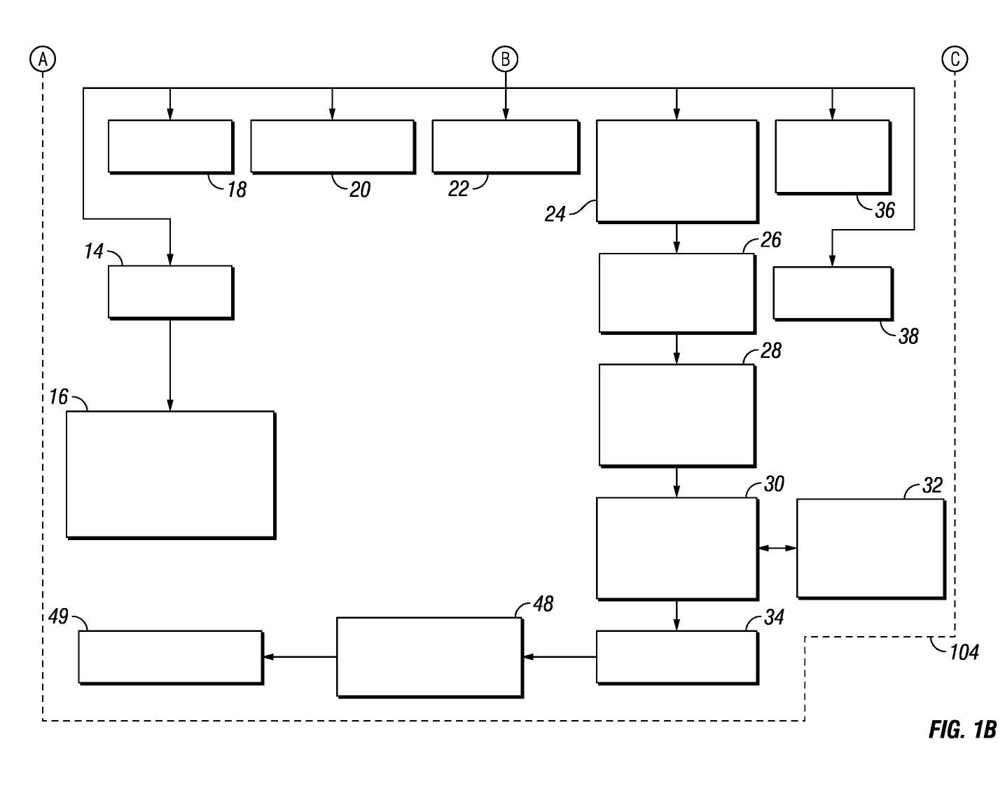

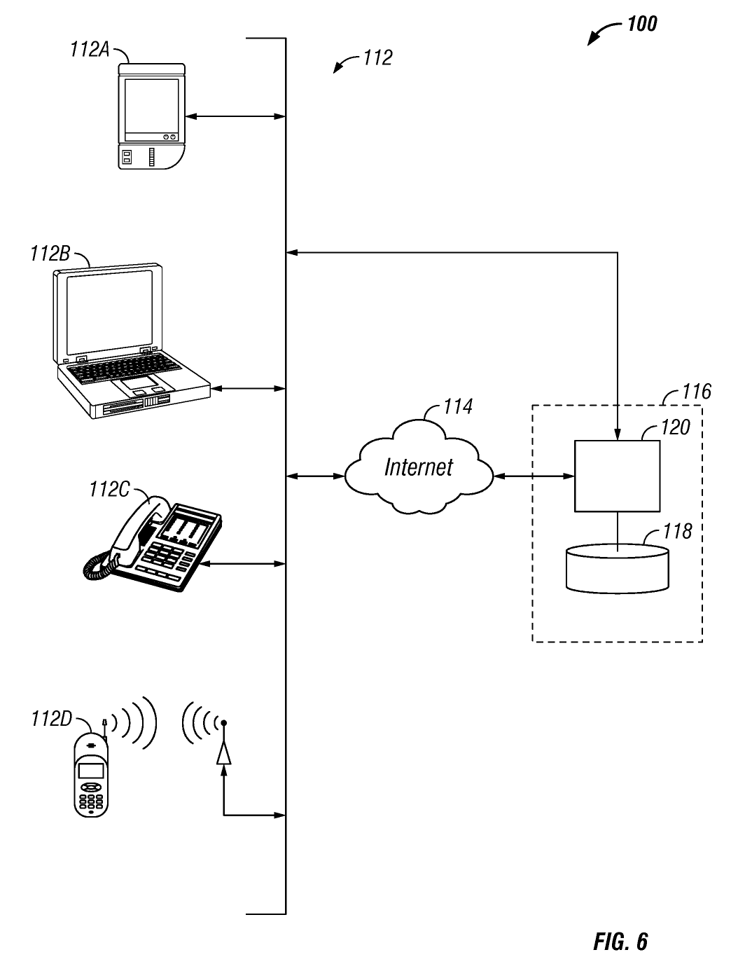

FIG. 1 is a schematic flowchart illustrating exemplary process steps to accomplish adding value from various parties to an account of a registrant and the registrant's use of the value. The parties can include third parties, the registrant, and even the provided of the services. An exemplary system 100 includes an electronic processor, as shown in more detail in FIG. 6, and a program coupled with the processor to enable at least third parties to provide value to the account of a registrant. The program can includes three overall blocks: a first block 102 of creating a gift account, a second block 104 of managing the gift account, and the third block 106 of adding value to the account to create an accumulated value that collectively can be used to at least partially purchase the selected services and products. The blocks can be accessed from a common entry point in step 2 described below. Further, the information provided in each block can be linked to information in the one or other blocks and linked to systems existing outside the blocks, such as accounting modules on a broader system.

The first block 102 generally includes a step 2 to access an electronic system with interfacing software, such as a website through the Internet or other accessible portal. The step 2 includes a link to access a step 4 for creating the account of a registrant as a benefactor of the value to be added to the account. In at least one embodiment, step 6 requires the registrant to be a member of a broader travel club or other registration, such as is found in the airline industry for frequent flyer miles. This aspect can increase the registration of entities for the frequent flyer miles as well as link common data together. In step 8, a previously unregistered user can enroll in the broader travel club or other registration. If the user is already a registered member of a broader club, then the user can be requested in step 10 to confirm the contact information previously on file. Further, the registrant can supply various information relevant to the registrant's account and the purpose for the account. For example, the registrant can include travel desires and dates, the costs of such travel, and other details as might be important to provide to others who may want to add value to the registrant's account. Naturally, such information could apply to other services and products as described above. In at least one embodiment, more than one listing of travel desires or other services (“events”) or products can be made.

Block 104 includes various features and steps for managing the account of the registrant. In step 2, the registrant can access the account and enter Step 12 through various links to manage the existing account. Several options can be provided to the registrant. For example, the registrant can be offered the option in step 14 of updating the gift account. The step 14 can link to step 16 in which the registrant can modify various contact information, travel or other products or services information, event details, and other related information. Further, the registrant can add co-recipients to facilitate third parties being able to find and access the gift account when adding value to that account. Third parties may recognize one individual over another individual, such as a relative in one family becoming wedded to another family's member in which the families may more easily only recognize their respective member. Thus, the account can be indexed multiple ways.

Another option in managing the account, shown in step 18, is to allow the registrant to view account balance details. The account balance details can provide updated information from third parties or even from the registrant or provider providing value to the account. An itemized menu list can be provided, such as might be found in an account statement. Contributions, uses, and purchases can also be shown.

Another option, shown in step 20, is to allow the registrant to send announcements regarding the account to selected individuals, businesses, or other entities. For example, the registrant may create an announcement announcing the existence of the account and offering the option to those who might desire to add value to the account. The announcement can include information necessary to access and add value into the account. The announcement can also include various direct links or other access information.

Relatedly, another option, shown in step 22, can allow the registrant to view announcements that have been sent. For example, the registrant may wish to provide additional information if the details of the selected products or services change, and may wish to review prior statements accordingly. Further, the registrant may wish to review the entities to whom the announcements have been sent and the dates of such announcements. The registrant can decide whether additional announcements to others or updates to previous announcements would be appropriate.

At some point, the registrant can decide to use the value in the registrant's account to apply the selected products or services. In step 24, the registrant can make, for example and without limitation, flight reservations using at least a portion of the value in the registrant's account. The registrant could enter a link on the website that directs the registrant in step 26 to a flight search page which might coincide to a typical flight search page that other users might access who do not have an account. Step 26 could include other products and services, as may be appropriate to the particular provider. Step 26 can be linked to the registrant's account for the value required.

In step 28, a registrant uses a regular link or path as others might use to select and find the products or services, such as airline travel. However, the offering of products or services is linked to the registrant's account. In step 30, the registrant can complete the purchase and optionally select the registrant's account and the value therein to at least partially pay for the selected products or services. The registrant in step 32 can optionally include funds from the registrant's account, if such funds are available, or include a combination of funds from the account with other funds available to the registrant, such as the registrant's charge card or bank account.

The above example illustrates using cash value acquired from third parties or the registrant's bank account or charge cards. However, it is to be understood that the value can include other types of value, such as in-kind value. For example, if the registrant is seeking to use the value for travel, the registrant could select the registrant's own frequent flyer miles as partial value. Similarly, the provider could include value in the form of discounts for the registrant for motels and other lodging or other value that is applicable to the particular product or services. In a similar manner, third parties can also provide in-kind value commensurate with the particular products or services for which the registrant has applied. In step 34, the registrant can receive a confirmation page regarding the use of the funds and the products or services selected. The registrant can then request the provider to provide the products or services in step 48, and the provider can provide the products or services to the registrant in step 49. The provider can directly provide such products or services to the registrant without the need for intermediaries that may charge excess or premium fees or have minimum expenditures for such services. Thus, the registrant can receive the full, intended value of the gift given to the registrant. As described herein, the provider can also provides added value and discounts as incentives or rewards.

Another option, shown in step 36, that is available for managing the account is reviewing the gift account terms and conditions. The provider of such products and services can elect to detail the terms and conditions of the accounts used to clarify issues and secure the registrants and other parties' acceptance of the terms under which their use is authorized.

Another option, shown in step 38, is to provide the ability to activate and deactivate the account. For example, after the expected date of the event or receipt of the product or services selected, the registrant may wish to preclude other past event donations or added value. Alternatively, the registrant may choose to delay obtaining the products or services after the account is created and sending announcements for more timely occurrences. Further, the provider of such services can activate and deactivate the account as necessary, for example, if there was a security breach or after an extended period of inactivity. The account in deactivated for a period of time, the account value can be sent by other channels to the registrant.

The third block 106 is primarily the block in which various parties can access the registrant's account and add value to the account. For example, a third party can access the website in step 2 in response to announcements sent in Step 20 and follow the links to finding the registrant's account in step 40. The third party can enter the identifying information of the registrant, such as names of the registrants or co-recipients if provided, travel information, or a combination of both to find the correct recipient in step 42. If there are several recipients with similar information, such as the same last name, a list of alternatives, such as various full names with more specific information, can be provided in step 44 to appropriately select the proper recipient. The third party in general exercises care to select the proper recipient to provide the value to the intended recipient.

In step 46, the third party can add value to the account selected. The value added can be either cash, such as from a charge card or bank account, in-kind products and services such as frequent flyer miles for airline travel, or combinations thereof Further, the third party can transfer value from another gift account into the registrant's account if the third party itself is a registrant with an account. In a similar fashion, the registrant can also provide value into the account by following the same steps or by using other links accessible to the registrant, such as at the time of purchase of the selected products or services or other appropriate times. The third party can include even the provider of the products and services, such as may be provided during a promotional incentive period. For example, the provider may wish to provide partial value for the selected products and services to encourage the registrant or third parties to add additional value to the registrant's account. Examples could be a discount during a specific promotion, travel miles if the products or the service selected was travel, opportunities for special trips to locations, or other products and services. The provider can either provide a discount or provide actual value into the account of the registrant based upon the registrant's selection of the particular products or services to be provided. Still further, the account value can be used for other purposes and special promotions, such as a travel club, upgraded club membership, such as a President's Club® membership, or other products and services. The value in the account can further be modified by moving value from another registrant's account with the same provider or another provider in cash, in-kind value or other value as may be appropriate. For example, cash or points from American Express, Discover, Master Card, or Visa can be converted to travel miles and deposited into the account as travel miles or other value. The registrant can receive a communication, such as through electronic mail, of the change in status of the registrant's account from contributions and debits from the account.

A variation on the kind of value can include gift certificates. For example, a third party can anonymously purchase for value and provide a gift certificate to a registrant. The gift certificate can include instructions for the registrant to go to the registrant's account, enter a code from the gift certificate, and receive value into the registrant's account.

Various entities as registrants can further create gift accounts for promotional or other usage. For example, an entity, such as a business, group of people, charity, institution, or other non-individual registrant, can establish an account. Value can be added to the account by the entity. The entity can choose how to apply the value. The value can be selectively used by various members of the entity or other individuals for services or products. Others, such as a provider of the services or products can add value to the account as well. As non-limiting examples, the value can represent compensation by the provider to an entity for advertising or a donation to a charitable entity.

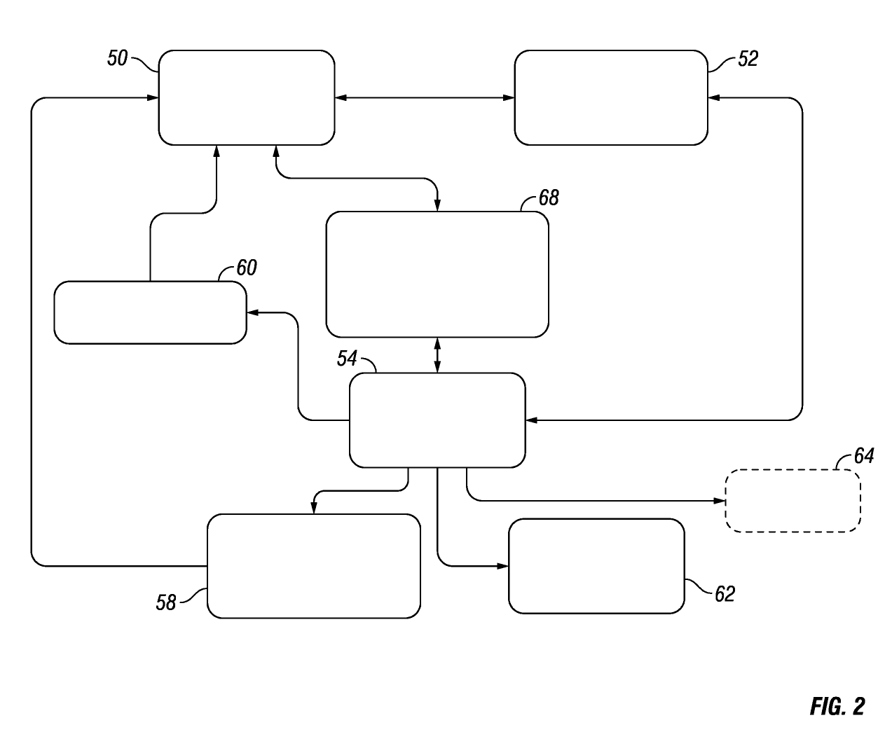

FIG. 2 is a schematic flowchart illustrating exemplary process steps detailing adding value to the account of the registrant. In general, a payment system 50 can access an account database 52 that contains the registrant's information to deposit the value added into the account. Such information can include a sales type that might designate, for example, the type of value and other information that may be desired to trace. Similarly, the payment system 50 can generate a data record 68 that would include such information as amount, deposit number, billing date and other information. The data records can be generated on a time specific basis, such as hourly, daily, weekly and so forth. The payment system 50 and account database 52 can interface with a general accounting system 54 that itself can interact as required with one or more modules 58, 60, 62, described below. The accounting system 54 can provide feedback to update the payment system 50 and account database 52.

When a third party, registrant, or other entity adds value to the account described above in FIG. 1, the payment system 50 is activated. The payment system 50 can access an account database 52 that stores at least some, if not all, of the information described above in reference to FIG. 1 where the account is set up with the registrant's contact information, travel or other selected products or services, and other details. Further, the account information can include the value of the selected products or services, balance details from step 18 of FIG. 1, whether the account is activated or deactivated from step 38, information to assist in finding the account from step 40, and records of value added to the account from step 46.

The account database 52 can interact with other accounting systems, such as general accounting system 54 that interfaces with other aspects of the particular provider. For example and without limitation, the accounting system 54 can interact with typical transactions as might be found in an airline industry that are extrinsic to the registrant's account described herein, including information and related transactions on non-registrants conducting business with the provider without such an account. The account database 52 can interact with such accounting system 54 and provide status, updates, sales information, contributions, and uses specific to the registrant's account. The information and related transactions can then be processed through the general accounting system 54. Further, the general accounting system 54 can provide feedback to the account database 52 to update the database and confirm that the account is adjusted accordingly. In at least one embodiment, the payment system 50 can also interact with the accounting system 54 by transferring and receiving information, such as contributions into the account with the appropriate billing information to transfer the value particular to the transaction. For example, if a third party adds value to the account through a charge card, then the payment system can send and receive such information with the general accounting system 54 that a charge on the third party's charge card should be processed. The accounting system 54 can provide a checks-and-balances between the payment system 50 and the account database 52. Thus, the payment system 50 and/or the account database 52 form an interface between the general accounting system 54 and the specific account information and related transactions of the registrant. If the information is incorrect and does not balance, then an error report can be generated from the accounting system to recommend intervention and reconciliation.

Once the information is transferred into the general accounting system 54 from either the payment system 50 or the registrant's account database 52, the accounting system 54 can interact with accounting modules found in the accounting system. Without limitation, these accounting modules can include a charge module 58, refund module 60, and a general accounting module 62. The charge card module 58 can include credit and debit card information for billing and reconciliation and other deposit information, such as verification codes or authorization, to use a charge card or credit chargebacks as needed. The charge module 58 can update the payment system 50 as appropriate. Similarly, the accounting system can interact with a refund module 60 to process any refunds, including e-tickets and other on-line transactions, that can be appropriate for the transaction and adjust the account balance as needed. The third module, general accounting module 62, can perform miscellaneous accounting functions that are nonspecific to the other modules. For example, the accounting module 62 can include reconciliation, billing questions and general accounting. Similar modules can exist to account for other types of value, such as travel miles, hotel stays, and other value. In at least one embodiment, a mileage module 64 can be added to the system to facilitate exchange using travel miles. The payment system 50 can issue a data record 68. The data record 68 can include various data fields, such as date of deposit, charge card information, transaction type, and other accounting information. The records can be generated on a time selected schedule, such as daily, hourly, or weekly in conjunction with the accounting system 54.

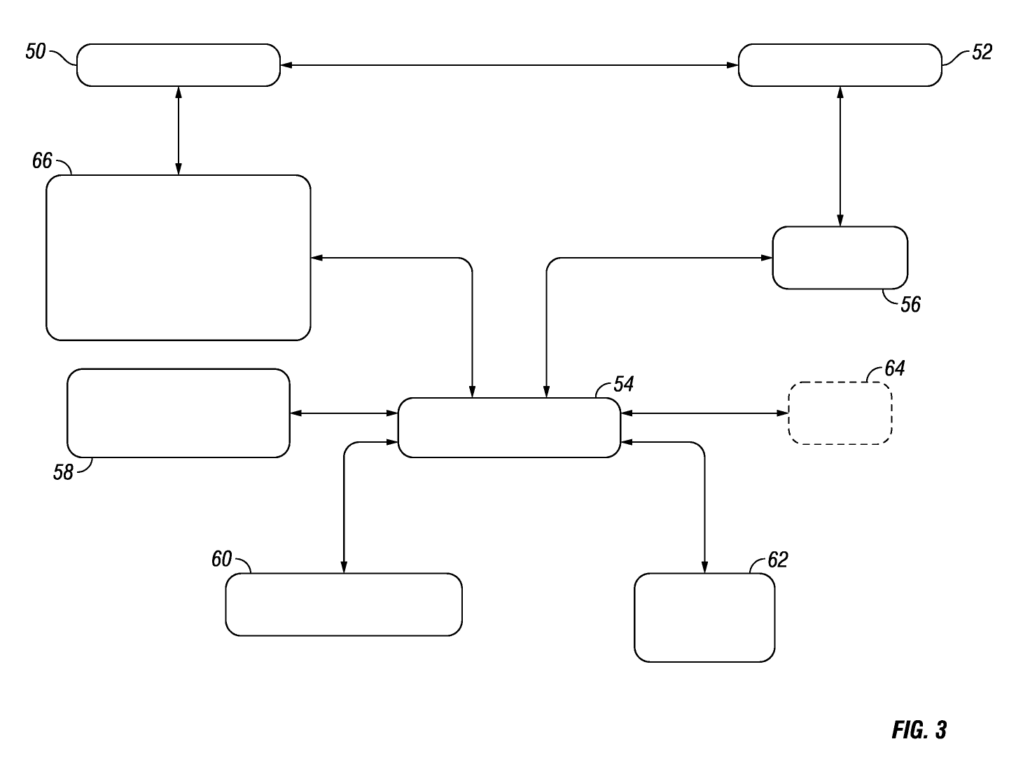

FIG. 3 is a schematic flowchart illustrating exemplary process steps detailing at least partially providing selected services or products to the registrant. Similar systems, database, and modules are shown in FIG. 3 as have been described in reference to FIG. 2. In addition to the previously described components, the flow chart includes interfacing the account database 52 with other system components that act independent of the registrant's account. For example, the provider may provide products or services in a standard format, such as airline ticketing for non-registered users. The complexity can be enormous. Thus, the account database 52 can interface with a value provision module 56 that may already be linked to the general accounting system 54. This coupling of the registrant's information in the database 52 to the module 56 enhances the system's ability to account and interact with an overall system 54. Other systems may be less complicated and can be independent without having to interface with such pre-existing or general systems. In either case, the selected product or service can be at least partially provided to the registrant in that the registrant can at least purchase the selected product or service so that the product or service can be received or used at some designated time by the registrant.

The registrant can decide to use value from the account and purchase a service, such as an airline ticket or other service or product. The payment system 50 can verify the account balance in the account database 52. The account database 52 can interact with the value provision module 56 to secure the related product or service, as an exchange for the selected value. In at least one embodiment, the value provision module 56 can issue an e-ticket sales file to the accounting system 54. The accounting system 54 can access as required the various modules, such as the charge module 58, refund module 60, and general accounting module 62. The payment system 50 can mark the selected product or service redeemed at the time of issuance and issue a data record 66. The data record 66 can include, for example, ticket information, exchange amount, total ticket amount, issue date, and account number. The records can be generated on a time selected schedule, such as daily, hourly, or weekly in conjunction with the accounting system 54.

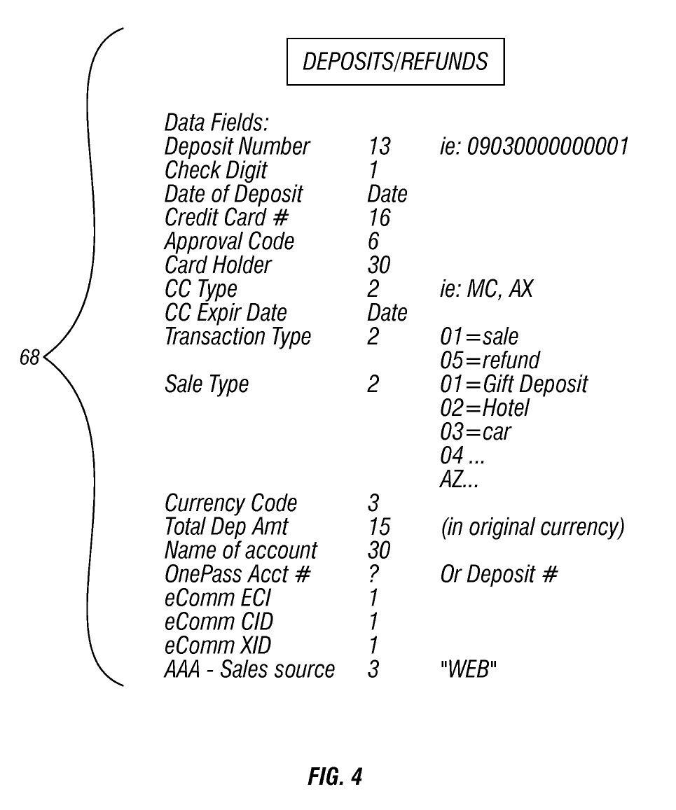

FIG. 4 is an exemplary listing of data fields for one or more records used in adding value to the account of the registrant. An exemplary data record 68 provided by the payment system 50 for deposits can include a number of fields that provides information useful for the accounting system and reconciliation of the different transactions. For example and without limitation, the data fields can include a deposit number which can be a number of digits, a check field, date of deposit, charge card number if used, approval code, cardholder name or other entity, the charge card type, such as American Express, Discover Master Card, and Visa, and the related expiration date. Further, the record can include a transaction type that can be whether the transaction is a sale or a refund, and a sale type of the transaction such as a deposit. For example, if the value is cash, the deposit can include a code for a cash deposit. If the value is used for products or services, such as airline miles, hotel, automobile, or other services, then the code can so indicate. The data record can include a currency code, to allow for foreign and domestic types of currencies, total deposit amount, and name on account. The data record 66 can include other information, such as information on another account with the service provider, such as a One Pass account number. The data record can also include other information to assist in transacting the deposit or refund. A further useful code can include the sale source as to the origination of the deposit from a website, gift card, or other source of interaction that added value to the account. The data can be gathered from linked systems and databases. Generally, the data record and deposit or credit information can be timed, so that the data is received before other data is generated based on such information, such as e-ticket sales data.

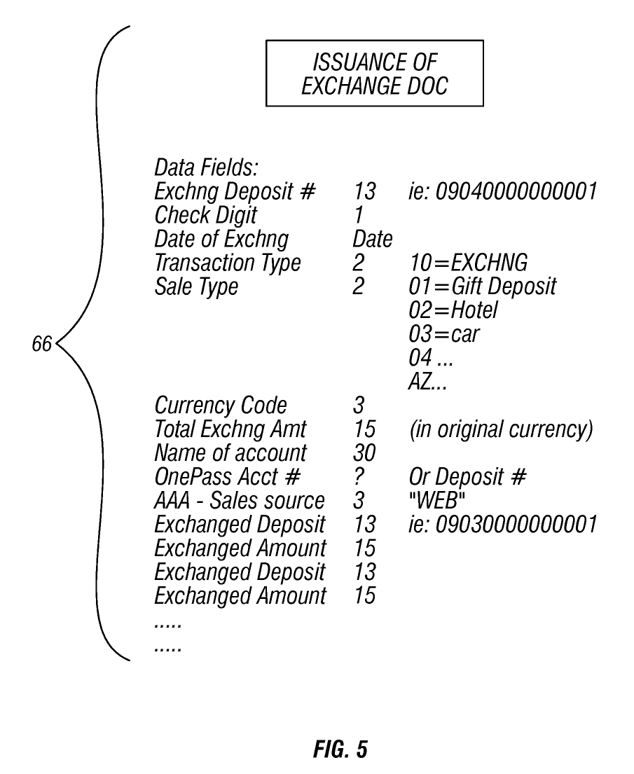

FIG. 5 is an exemplary listing of data fields for one or more records used in at least partially providing the services or products to the registrant. An exemplary data record 66, used in connection with a registrant using value from the account, can include various exemplary fields, similar to the fields described in reference to FIG. 4 for the data record 68. Such data fields can include an exchange deposit number that would indicate the particular transaction for which value was used for a particular selected product or service, check digit, date of exchange, transaction type, sales type, currency code, total exchange amount, name on the account, references to other accounts, and sale source, as has been described above. In addition, the data record 66 can include exchanged deposit numbers and exchanged deposit amounts. Multiple exchanged deposit numbers and amounts can be included in the data record 66. These deposit records and amount records can be linked to specific deposit numbers and deposit amounts found in the data record 66 so that the records can be correlated with each other. For example, data record 66 can include a code that indicates it is an exchange deposit number (in the example, 0904 . . . ) that can be linked with one or more exchanged deposit codes from the data record 68 (in the example, 0903 . . . ), described in reference to FIG. 4. If the registrant has a series of exchanged deposit numbers or codes that are used for the particular product or service, then the data record 66 can list the various deposits and amounts used. In general, the total of the deposits would be at least as great as the value used for the product or service. In a similar fashion as the data record 68 described in FIG. 4, the data record 68 and related information can be timed, so that the data is received before other data is generated based on such information.

One feature that is apparent from the data records 66, 68 is that additional codes can be easily added for additional types of value. For example, if travel miles are part of the value to be added to the registrant's account, then a code indicating mileage as “currency” under the currency code data field can be used. The currency code can be given a multiplier of greater or less than unity to adjust for its relative value compared to, for example, a cash value.

FIG. 6 is an exemplary system having an electronic processor and input device used to receive and process information from various parties and at least partially provide services or products to the registrant. The system 100 includes a program having one or more of the exemplary steps, databases, modules, and systems described above in FIGS. 1-4. In addition, the system 100 includes various physical elements as well. For example, the system 100 generally includes one or more input/output devices 112. The input/output devices can function as input devices, output devices, or a combination thereof. For example and without limitation, an input device can include a portable desktop assistant (PDA) 112A, a computer 112B, a land line telephone 112C, a wireless communication device 112D, such as a cellular phone, and other devices that can be used to provide input to the system. Such input can include various information described above, such as the registrant's identity and contact information, desired products or services, emails and other notifications to potential third party contributors, transactions related to the account's value, and other such information.

Similarly, the information can include information provided by various parties, such as value to be added to the registrant's account, any charge card or bank account information, mileage, or other forms of value to be provided to the account. The input/output devices 112 can communicate to other portions of the system 100 through direct connections or indirect connections over a network 114, such as the Internet, local area networks, and other indirect communication systems.

The system 100 can further include an electronic processor 116. The electronic processor can be one or more individual units. If a plurality of units is used, such as one or more servers, the units can be located adjacent to each other or distant from each other and coupled together through a computer network. The electronic processor 116 generally includes a processing portion 120 that can execute the programs and perform system and data integrity checks, and may be software or firmware based. The electronic processor 116 also generally includes a memory portion 118. The memory portion 118 can be integral to the electronic processor 116 or separate therefrom. Further, the memory portion 118 can be located distally from the processing portion 120 and coupled through electronic communications. The memory portion 118 can include various types of memory, such as dynamic, random access, read-only, and other electronic data storage media and systems. The memory portion 118 can further store the various software programs used by the processing portion 120.

In general, a registrant can use one or more input/output devices 112 to enter the information that is received by the electronic processor 116 and stored in the memory portion 118. The input/output devices can function at least as input devices in providing input to the electronic processor 116. Various parties, whether third parties, the registrant or provider, can access an account stored in the electronic processor 116 and add value to the account. Alternatively, the registrant may use value in the account for a selected product or service. The registrant or the third party can receive confirmations, or other output from the electronic processor 116 through the input/output devices 112.

The invention has been described in the context of preferred and other embodiments and not every embodiment of the invention has been described. Apparent modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intends to protect all such modifications and improvements to the full extent that such falls within the scope or range of equivalent of the following claims.

The various methods and embodiments of the invention can be included in combination with each other to produce variations of the disclosed methods and embodiments, as would be understood by those with ordinary skill in the art, given the understanding provided herein. Also, various aspects of the embodiments could be used in conjunction with each other to accomplish the understood goals of the invention. Also, the directions such as “top,” “bottom,” “left,” “right,” “upper,” “lower,” and other directions and orientations are described herein for clarity in reference to the figures and are not to be limiting of the actual device or system or use of the device or system. Unless the context requires otherwise, the word “comprise” or variations such as “comprises” or “comprising”, should be understood to imply the inclusion of at least the stated element or step or group of elements or steps or equivalents thereof, and not the exclusion of a greater numerical quantity or any other element or step or group of elements or steps or equivalents thereof. The term “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, directly or indirectly with intermediate elements, one or more pieces of members together and can further include without limitation integrally forming one functional member with another in a unity fashion.

The device or system may be used in a number of directions and orientations. Further, the order of steps can occur in a variety of sequences unless otherwise specifically limited. The various steps described herein can be combined with other steps, interlineated with the stated steps, and/or split into multiple steps. Additionally, the headings herein are for the convenience of the reader and are not intended to limit the scope of the invention.

Further, any references mentioned in the application for this patent as well as all references listed in the information disclosure originally filed with the application are hereby incorporated by reference in their entirety to the extent such may be deemed essential to support the enabling of the invention. However, to the extent statements might be considered inconsistent with the patenting of the invention, such statements are expressly not meant to be considered as made by the Applicant(s).

1. A method for providing services or products for value to a registrant of a provider, comprising:
allowing the registrant to activate a web based account on an electronic processor;
allowing third parties other than the registrant and the provider to add monetary value into the account to establish an accumulated value for the registrant through an input device to the electronic processor;
allowing the registrant to apply at least a portion of the accumulated value to selectable services or products offered by the provider; and
the provider at least partially providing the selected services or products to the registrant.

2. The method of claim 1, further comprising allowing the registrant, the provider, or a combination thereof to add value into the account in addition to allowing the third parties to add value.

3. The method of claim 2, further allowing the registrant to add cash value, credit value or transfer value, allowing the provider to add in-kind value, and allowing the third parties to add cash value, credit value, transfer value, and in-kind value to the account.

4. The method of claim 2, further comprising allowing the provider to add incentives to use with predetermined services or products.

5. The method of claim 1, wherein the provider comprises an airline industry company and the services comprise travel services.

6. The method of claim 1, wherein the services provided are travel services to predetermined sites.

7. The method of claim 1, further comprising validating a credit card number prior to adding credit value to the account.

8. The method of claim 1, further comprising allowing the registrant to combine at least a portion of the account value with other value independent of the account to select a service or product offered by the provider.

9. The method of claim 1, wherein the provider accesses the account information and contacts the recipient regarding the account.

10. The method of claim 9, wherein the provider offers incentives based on the recipient's searching or selections of services or products.

11. The method of claim 10, wherein the incentives are time, location, or value based incentives or a combination thereof.

12. The method of claim 1, further comprising interfacing information on a transaction from the account of the registrant to an accounting system having information of entities other than one or more registrants.

13. A method for providing travel services for value to a registrant of an airline industry company, comprising:
allowing the registrant to activate a web based account on an electronic processor;
allowing third parties other than the registrant and the airline industry company to add monetary value to the account to establish an accumulated value for the registrant through an input device to the electronic processor;
allowing the registrant to apply at least a portion of the accumulated value to selectable travel services offered by the airline industry company; and
the airline industry company at least partially providing the travel services to the registrant.

14. The method of claim 13, further comprising allowing the registrant, the airline industry company, or a combination thereof to add value to the account in addition to allowing the third parties to add value.

15. The method of claim 14, further allowing the registrant to add cash value, credit value or transfer value, allowing the an airline industry company to add in-kind value, and allowing the third parties to add cash value, credit value, transfer value, and in-kind value to the account.

16. The method of claim 14, further comprising allowing the airline industry company to add incentives to use with predetermined services or products.

17. The method of claim 13, further comprising allowing the registrant to combine at least a portion of the account value with other value independent of the account to select one or more of the travel services or one or more products offered by the airline industry company.

18. The method of claim 13, wherein at least a portion of the added value comprises travel miles from travel accounts of the third parties.

19. A system for providing services or products for value to a registrant of a provider, comprising:
a database;
an electronic processor coupled to the database;
an input device remotely linkable to the processor;
an output device remotely linkable to the processor;
a program coupled to the processor and database and adapted to receive input from the input device that allows:
the registrant to activate a web based account;
third parties other than the registrant and the provider to add monetary value to the account to establish an accumulated value for the registrant;
the registrant to apply at least a portion of the added value to selectable services or products offered by the provider; and
the provider to at least partially provide the selected services or products directly to the registrant.

20. The system of claim 19, wherein the program allows the registrant, the provider, or a combination thereof to add value to the account in addition to allowing the third parties to add value.

21. The system of claim 20, wherein the program allows the registrant to add cash value, credit value or transfer value, allowing the provider to add in-kind value, and allowing the third parties to add cash value, credit value, transfer value, and in-kind value to the account.

22. The system of claim 20, wherein the program allows the provider to add incentives to use with predetermined services or products.

23. The system of claim 19, wherein the provider comprises an airline industry company and the services comprise travel services.

24. The system of claim 19, wherein the services provided are travel services to predetermined sites.

25. The system of claim 19, wherein the program allows the registrant to combine at least a portion of the account value with other value independent of the account to select a service or product offered by the provider.
